(19) United States
(12) Patent Application Publication
(10) Pub. No.: US 2025/0292578 A1
(43) Pub. Date: Sep. 18, 2025

(54) DYNAMIC MAPPING USING IMAGE DATA

(71) Applicant: DoorDash, Inc., San Francisco, CA (US)

(72) Inventors: Weiyu Zhou, Bellevue, WA (US); Sarah Olsen, Brooklyn, NY (US); Chuqi Wang, Mountain View, CA (US)

(21) Appl. No.: 19/082,577

(22) Filed: Mar. 18, 2025

Related U.S. Application Data
(60) Provisional application No. 63/566,563, filed on Mar. 18, 2024.

(51) Int. Cl. G06V 20/50; G06V 10/74; G06V 30/422

(52) U.S. Cl. CPC G06V 20/50; G06V 10/761; G06V 30/422

(57) ABSTRACT

A method includes a computer receiving image data of an image of a shelf unit with specific items and item tags comprising machine readable codes adjacent to the specific items. The computer can identify the specific items in the image. The computer can create a current map based on the specific items in the image. The computer can determine differences between the current map and one or more historical maps of historical items from past images. The computer can determine that one or more of the items from the one or more historical maps are not present in the current map.

### CROSS-REFERENCES TO RELATED APPLICATIONS

This application claims the benefit of U.S. Provisional Application No. 63/566,563, filed Mar. 18, 2024, which is herein incorporated by reference in its entirety for all purposes.

### SUMMARY

One embodiment is related to a method comprising: receiving, by a computer, image data of an image of a shelf unit with specific items and item tags comprising machine readable codes adjacent to the specific items; identifying, by the computer, the specific items in the image; creating, by the computer, a current map based on the specific items in the image; determining, by the computer, differences between the current map and one or more historical maps of historical items from past images; and determining, by the computer, that one or more of the items from the one or more historical maps are not present in the current map.

Another embodiment is related to a computer comprising: a processor; and a computer-readable medium coupled to the processor, the computer-readable medium comprising code executable by the processor for implementing a method comprising: receiving image data of an image of a shelf unit with specific items and item tags comprising machine readable codes adjacent to the specific items; identifying the specific items in the image; creating a current map based on the specific items in the image; determining differences between the current map and one or more historical maps of historical items from past images; and determining that one or more of the items from the one or more historical maps are not present in the current map.

Another embodiment is related to a system comprising: a central server computer; an image database in communication with the central server computer; and an image analysis computer in communication with the image database, the image analysis computer comprising: a processor; and a computer-readable medium coupled to the processor, the computer-readable medium comprising code executable by the processor for implementing a method comprising: receiving image data of an image of a shelf unit with specific items and item tags comprising machine readable codes adjacent to the specific items; identifying the specific items in the image; creating a current map based on the specific items in the image; determining differences between the current map and one or more historical maps of historical items from past images; and determining that one or more of the items from the one or more historical maps are not present in the current map.

Further details regarding embodiments of the disclosure can be found in the Detailed Description and the Figures.

### BRIEF DESCRIPTION OF THE DRAWINGS

FIG. 1 shows a block diagram illustrating a fulfilment system according to embodiments of the disclosure.

FIG. 2 shows a block diagram of an analysis system according to embodiments.

FIG. 3 shows a block diagram of components of an image analysis computer according to embodiments.

FIG. 4 shows a flowchart illustrating a method according to embodiments.

FIG. 5 shows block diagram illustrating maps according to embodiments.

FIG. 6 shows a block diagram illustrating a map with a neighbor item and target items according to embodiments.

FIG. 7 shows a block diagram illustrating edge feature extraction according to embodiments.

FIG. 8 shows a diagram illustrating historical maps according to embodiments.

FIG. 9 shows maps illustrating identifying an item tag being removed from a shelf unit according to embodiments.

FIG. 10 shows a block diagram illustrating a data processing system and a data processing method according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

“Image data” can include information related to a visible impression obtained by a camera, telescope, microscope, or other device, or displayed on a computer or video screen. Image data can include a plurality of pixels, where each pixel can include data that indicates how that pixel is displayed (e.g., a color value, etc.).

A “shelf unit” can include a surfaces upon which items can be displayed. A shelf unit can include horizontal shelves, gondola shelfs, wire rack shelfs, etc. A shelf unit can display a plurality of items and item tags that relate to the items.

An “item tag” can include a label that includes information about an item. An item tag can include a machine readable code (e.g., a barcode, a QR code, etc.), a price, SKU codes, and/or other information that describes the related item.

A “barcode” can include a machine-readable code that includes a plurality of bars. A barcode can be in the form of numbers and a pattern of parallel lines of varying widths (e.g., bars). A barcode can correspond to and identify a specific item.

A “map” can include data that has a corresponding relationship to other data. A map can include data related to items and how the items relate to one another on a shelf unit. A map can be a topological graph. In some embodiments, a map can be a planogram.

A “topological graph” can include a representation of a graph in a plane of distinct vertices connected by edges. The distinct vertices in a topological graph may be referred to as “nodes.” Each node may represent specific information for an event or may represent specific information for a profile of an entity or object. The nodes may be related to one another by a set of edges, E. An “edge” can include an unordered pair composed of two nodes as a subset of the graph G=(V, E), where is G is a graph comprising a set V of vertices (nodes) connected by a set of edges E. An edge may be associated with a numerical value, referred to as a “weight,” that may be assigned to the pairwise connection between the two nodes. The edge weight may be identified as a strength of connectivity between two nodes and/or may be related to a cost or distance, as it often represents a quantity that is required to move from one node to the next.

A “planogram” can include diagram that shows how and where specific items can and/or should be placed on shelves. A planogram can indicate items and item locations on a shelf. In some cases, a planogram can indicate a size of an item on a shelf.

The term “node” can include a discrete data point representing specified information. Nodes may be connected to one another in a topological graph by edges, which may be assigned a value known as an edge weight in order to describe the connection strength between the two nodes. For example, a first node may be a data point representing a first item on a shelf unit, and the first node may be connected in a graph to a second node representing a second item on a shelf unit. An edge weight may also be used to express a cost or a distance required to move from one node to the next. For example, a first node may be a data point representing a first position of a first item, and the first node may be connected in a graph to a second node for a second position of a second item. The edge weight may be the distance between the first position and the second position.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data.

Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Managing inventory is a time-consuming and challenging process for service providers. Most service providers (e.g., retail merchants such as grocery stores) are only able to count their inventory between once per week and once per month. The difficulties compound when the service provider shares information regarding what items are actually available at the service provider location.

In some cases, transporters can obtain items at service provider locations based on orders provided by end users. The transporters can deliver the items to the end users. However, the end users can select to receive items in a delivery application that are actually not available at the service providers (e.g., the items may be no longer available). If this occurs, it can be difficult and time consuming for the transporter to locate the item or search for a similar item at the service provider or another service provider.

Currently, service providers can use handheld barcode scanners to scan individual item tags on shelves. The service providers can place the handheld barcode scanner close (e.g., a few inches) to the item tag to scan the single item tag. Scanning the item tag can allow the handheld barcode scanner to identify the one item associated with the one scanned item tag. Scanning can be slow since employees in a store need to scan the items one by one in the store.

It takes a long time for a service provider to update their inventory system to represent the items on the shelves at the service provider. The updates to an organization that manages a delivery application would also be delayed.

It is difficult to track long term changes of items at service provider locations. For example, a long term change can include an item and associated item tag being removed from a shelf entirely. Another long term change can include an item and associated item tag being moved to a different position at a service provider location (e.g., a different spot on the shelf, a different shelf in the store, etc.). These types of long term changes, which effect the long term layout of items, are difficult to track using a handheld barcode scanner, since the item tags with the barcodes are removed from the shelf.

Embodiments of the disclosure address this problem and other problems individually and collectively.

Embodiments of the disclosure allow for user devices to capture image data of shelf units (e.g., a portion of larger shelf or an entire shelf) such that the image data can be utilized to detect long term missing items (e.g., long term out of stock (LT OOS), discontinued, etc.). The long term changes can be used to update item listings in a delivery application, such that end users cannot select long term out of stock items. Further, keeping the item listings up to date can aid transporters using the delivery application to correctly identify which shelf unit the item is actually on at the service provider location.

Embodiments can provide for systems and methods of creating maps of items in images of shelf units at the service provider location. The maps can be evaluated over time with historical maps to determine long term changes (e.g., determine missing items, determine item location changes, etc.).

Embodiments can provide for an image analysis computer that can process image data. The image analysis computer can obtain image data of an image from a database. The image data can be captured by a user device (e.g., operated by a transporter). The image can be of a shelf unit with specific items and item tags comprising machine readable codes adjacent to the specific items.

The image analysis computer can detect items that are removed from the shelf unit, which can indicate a potential long term out of stock event. The image analysis computer can also detect newly added item tags. To detect these changes, the image analysis computer can construct a map of store items by evaluating images that include items and item tags. For example, the image analysis computer can identify specific items in an image and then create a map of the specific items in the image. The map can be a data structure such as a graph that includes a plurality of nodes and a plurality of edges.

In some embodiments, a map can be a planogram. The planogram can indicate locations of specific items on a shelf unit. The planogram can indicate a relative positioning of each item to one another.

The image analysis computer can compare a current map of items with one or more historical maps of historical items from past images. The image analysis computer can determine differences between the current map and the one or more historical maps. Based on the differences, the image analysis computer can determine that one or more of the items from the one or more historical maps are not present in the map of specific items. The image analysis computer can generate and store an item information data entry that indicates that the item is no longer present in the current map, but was present in one or more historical maps. Item listings in a delivery application or an inventory application can be updated to reflect the changes indicated in the item information data entry.

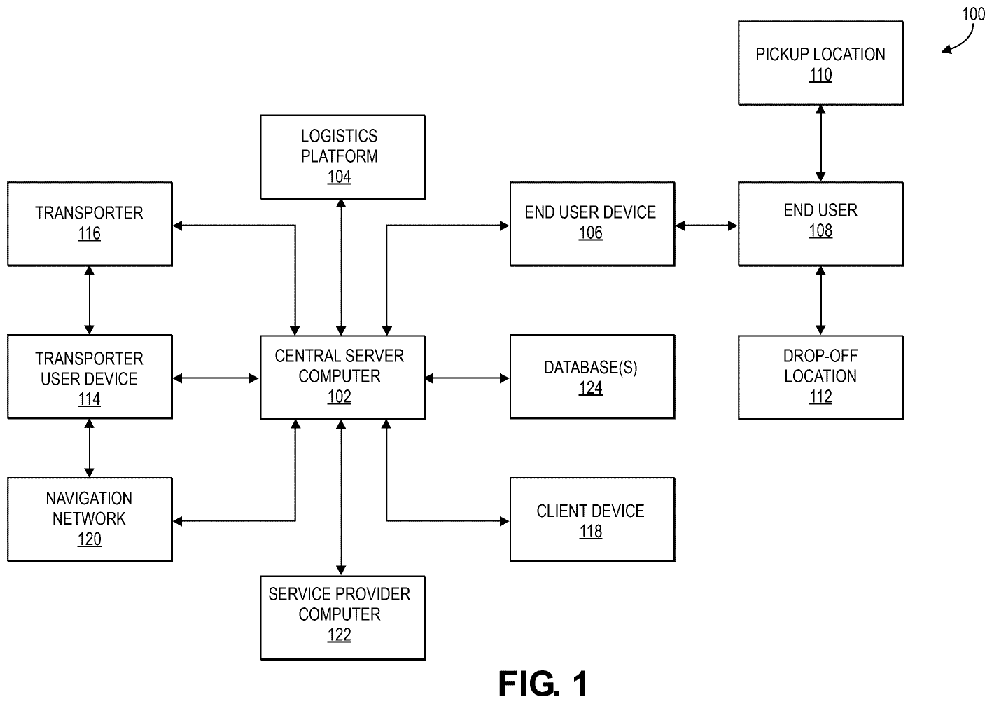

FIG. 1 shows a block diagram illustrating a fulfilment system according to embodiments of the disclosure. The system of FIG. 1 includes a central server computer 102, a logistics platform 104, an end user device 106, an end user 108, a pickup location 110, a drop-off location 112, a transporter user device 114, a transporter 116, a client device 118, a navigation network 120, a service provider computer 122, and database(s) 124.

The central server computer 102 can be in operative communication with the logistics platform 104, the end user device 106, the transporter user device 114, the client device 118, the navigation network 120, the service provider computer 122, and the database(s) 124. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although FIG. 1 shows one transporter 116, there can be two, three, or more transporters, transporter user devices, etc.

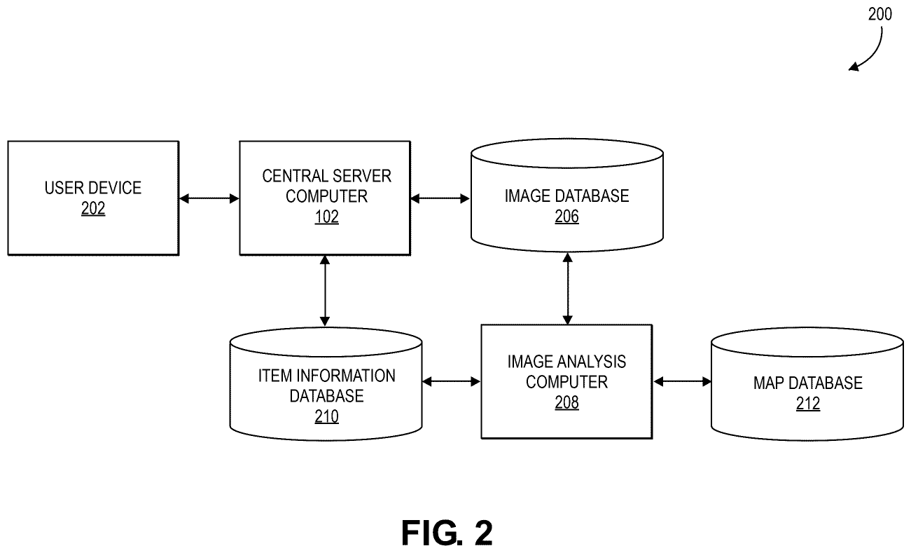

Messages between the devices and the computers in the system 100 in FIG. 1 (as well as FIG. 2) can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive images from user devices that include the end user device 106 and the transporter user device 114. The central server computer 102 can store the images into an image database.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations and drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be a system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pickup an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such as a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfil a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can be operated by an operator or can be autonomous. The vehicle can include a car, a truck, a van, a motorcycle, a bicycle, a drone, or other vehicle.

The client device 118 can request information from the central server computer 102. The client device 118 can be operated by a user that requests information from the central server computer 102 related to a delivery. In some embodiments, the client device 118 can be the transporter user device 114. In other embodiments, the client device 118 can be the end user device 106.

The navigation network 120 can provide navigational directions to the transporter user device 114. For example, the transporter user device 114 can obtain a location from the central server computer 102. The location can be a service provider parking location, a service provider location, an end user parking location, an end user location, etc. The navigation network 120 can provide navigational data to the location. For example, the navigation network 120 can be a global positioning system that provides location data to the transporter user device 114.

The service provider computer 122 include computers operated by a service provider. For example, the service provider computer 122 can be a food provider computer that is operated by a food provider. The service provider computer 122 can offer to provide services to the end user 108 of the end user device 106. In embodiments of the invention, the service provider computer 122 can receive requests to prepare one or more items for delivery from the central server computer 102. The service provider computer 122 can initiate the preparation of the one or more items that are to be delivered to the end user 108 of the end user device 106 by the transporter 116 of the transporter user device 114.

The database(s) 124 can include any suitable database. The database may be a conventional, fault tolerant, relational, scalable, secure database such as those commercially available from Oracle™ or Sybase™. The database(s) 124 can store fulfilment data, resource data, image data, etc.

FIG. 2 shows an analysis system 200 according to embodiments of the disclosure. The analysis system 200 comprises a user device 202, a central server computer 102, an image database 206, an image analysis computer 208, an item information database 210, and a map database 212.

The user device 202 can be in operative communication with the central server computer 102. The central server computer 102 can be in operative communication with the image database 206 and the item information database 210. The image analysis computer 208 can be in operative communication with the image database 206, the item information database 210, and the map database 212.

For simplicity of illustration, a certain number of components are shown in FIG. 2. It is understood, however, that embodiments of the invention may include more than one of each component. In addition, some embodiments of the invention may include fewer than or greater than all of the components shown in FIG. 2.

The user device 202 can include an end user device or a transporter user device operated by a user, or some other device such as a client device operated by an entity such as a resource provider and inventor manager. The user device 202 can include a device such as a smartphone, a wearable device, a laptop computer, etc. The user device 202 can include a camera that can capture image data of an image. The user device 202 can provide image data for one or more images to the central server computer 102.

In some embodiments, the user device 202 can be operated by a transporter during a fulfilment request (e.g., a delivery) of an item from a service provider location to an end user, or at some other time. The transporter can be prompted by the user device 202 to capture image data using the user device 202 of a shelf unit at the service provider location. The user device 202 can include a camera capable of capturing image data. After obtaining the image data, the user device 202 can provide the image data to the central server computer 102. The user device 202 can also provide additional data related to the image data to the central server computer 102. For example, the user device 202 can provide a service provider location, a service provider identifier, a service provider location identifier, an aisle number, user device orientation data, image metadata, and/or other data related to the service provider location, shelf unit(s), and/or user device 202.

In some embodiments, the system 200 can include a plurality of user devices that are in communication with the central server computer 102. Each user device of the plurality of user devices can provide additional image data to the central server computer 102.

The central server computer 102 can include a server computer that can communicate with a plurality of user devices to obtain image data and aid in processing fulfillment requests to provide resources from service providers to end users via transporters. The central server computer 102 can store received image data into the image database 206.

The central server computer 102 can maintain and update item listings that can be accessible on a delivery application managed by the central server computer 102. The delivery application can be installed on end user devices and can allow end users to select items from the item listings to have delivered to the end user from a service provider location by a transporter. The central server computer 102 can update item listings based on item information data entries in the item information database 210.

In some embodiments, the central server computer 102 can maintain and update item listings on the delivery application using out of stock data from the item information database 210 as well as inventory information provided from the service provider computer 122. For example, the item information database 210 can indicate that a particular item is in stock at the service provider location. The service provider computer 122 can provide inventory information that indicates that there are twelve instances of the particular item at the service provider location. The central server computer 102 can update the item listing for the particular item based on the information from the item information database 210 and the information from the service provider computer 122.

The image database 206 can store image data. The image database 206 can store information that relates the image data other data. For example, the image database 206 can store the image data in association with the service provider location, the service provider identifier, the service provider location identifier, the aisle number, user device orientation data, the image metadata, and/or other data.

The image analysis computer 208 can include computer that is configured to process image data. The image analysis computer 208 can be a laptop computer, a desktop computer, a server computer, etc. The image analysis computer 208 can obtain image data from the image database 206. The image analysis computer 208 can analyze the image data.

The image analysis computer 208 can include computer that is configured or programmed to process image data. The image analysis computer 208 can be a laptop computer, a desktop computer, a server computer, etc. The image analysis computer 208 can obtain image data from the image database 206. The image analysis computer 208 can receive image data of an image of a shelf unit with specific items and item tags comprising barcodes adjacent to the specific items. The image analysis computer 208 can analyze the image data.

The image analysis computer 208 can identify specific items in the image and then create a map of the specific items in the image. The map can indicate where on a shelf unit each specific item is located in relation to other specific items. The image analysis computer 208 can compare the map of specific items with one or more historical maps of historical items from past images. The image analysis computer 208 can then determine differences between the map of specific items and the one or more historical maps. Based on the differences, the image analysis computer 208 can determine that one or more of the items from the one or more historical maps are not present in the map of specific items. As such, the image analysis computer 208 can identify that the items are no longer present on the shelf unit. The image analysis computer 208 can also determine how long (e.g., a length of time) the specific items have been absent from the shelf unit.

The image analysis computer 208 can identify specific items in the image. The image analysis computer 208 generate a current map based on the specific items in the image. The current map can be a representation of the specific items on the shelf unit in relation to one another. The current map can be a graph that includes a plurality of nodes and a plurality of edges.

The image analysis computer 208 can determine differences between the current map and one or more historical maps of historical items from past images. Based on the differences, the image analysis computer 208 can determine that one or more of the items from the one or more historical maps are not present in the current map.

In some embodiments, after processing the image data, the image analysis computer 208 can generate an item information data entry that indicates that the item is no longer present in the current map, but was present in one or more historical maps. The image analysis computer 208 can store the item information data entry into the item information database 210.

The item information database 210 can store item information data entries for items that are provided by service providers to end users via transporters. The item information database 210 can store information that can indicate that a particular item is missing, removed from the shelf unit, etc. The item information database 210 can store item identifiers (e.g., item name, item number, etc.) along with an indication of whether or not an item was removed from the shelf units at a service provider location.

The image analysis computer 208 can store generated maps into the map database 212. The map database 212 can store maps (e.g., graphs). The map database 212 can store a plurality of historical maps that are stored in association with a service provider location identifier. Each map stored in the map database 212 can be stored in a data structure such that each map can be retrieved based on a service provider identifier, a service provider location identifier, and/or a shelf unit identifier (e.g., an aisle number).

The image database 206, the item information database 210, and the map database can include any suitable databases. The databases may be a conventional, fault tolerant, relational, scalable, secure database such as those commercially available from Oracle™ or Sybase™.

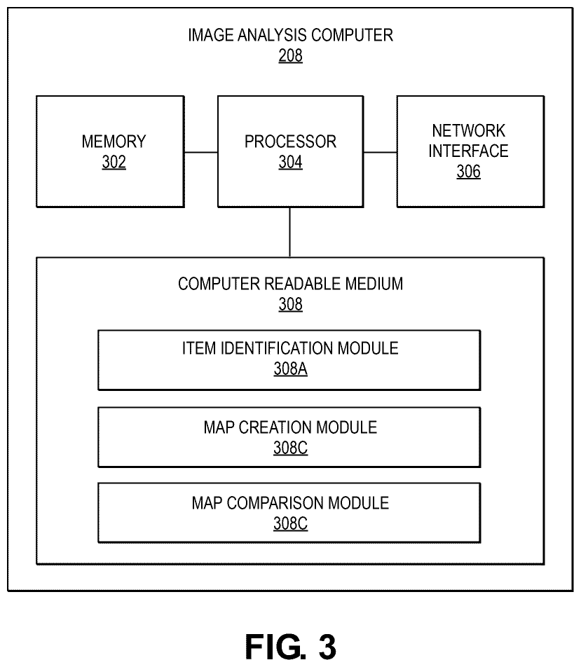

FIG. 3 shows a block diagram of the image analysis computer 208 according to embodiments. The exemplary image analysis computer 208 may comprise a processor 304. The processor 304 may be coupled to a memory 302, a network interface 306, and a computer readable medium 308. The computer readable medium 308 can comprise modules. The computer readable medium 308 can include an item identification module 308A, a map creation module 308B, and a map comparison module 308C.

The memory 302 can be used to store data and code. For example, the memory 302 can store machine learning model training data, machine learning model weights, image data, barcode data, item data, etc. The memory 302 may be coupled to the processor 304 internally or externally (e.g., cloud based data storage), and may comprise any combination of volatile and/or non-volatile memory, such as RAM, DRAM, ROM, flash, or any other suitable memory device.

The computer readable medium 308 may comprise code, executable by the processor 304, for performing a method comprising: receiving, by a computer, image data of an image of a shelf unit with specific items and item tags comprising machine readable codes adjacent to the specific items; identifying, by the computer, the specific items in the image; creating, by the computer, a current map based on the specific items in the image; determining, by the computer, differences between the current map and one or more historical maps of historical items from past images; and determining, by the computer, that one or more of the items from the one or more historical maps are not present in the current map.

The item identification module 308A may comprise code or software, executable by the processor 304, for identifying items. The item identification module 308A, in conjunction with the processor 304, can identify items directly or indirectly using item tags.

The item identification module 308A, in conjunction with the processor 304, can determine item tag data from the image data. The item identification module 308A, in conjunction with the processor 304, can identify the item tags on the shelf unit(s) in the image data. The item identification module 308A, in conjunction with the processor 304, can extract information (e.g., item name, machine readable code, price, etc.) from each item tag in the image data. For example, the item identification module 308A, in conjunction with the processor 304, can identify item tags in the image data using a machine learning model to identify item tags in images or other suitable item tag determination method. The item identification module 308A, in conjunction with the processor 304, can extract data from the item tags in the image data. For example, the image analysis computer 208 can extract item data such as a name, a price, a promotion, a price per unit, etc. from the item tag. The item identification module 308A, in conjunction with the processor 304, can also extract a machine readable code (e.g., a barcode, a QR code, etc.) from the item tag, where the machine readable code identifies the item and can indicate information about the item. For example, the image analysis computer 208 can determine additional information for each item based on the machine readable codes on the item tags.

In some embodiments, the item identification module 308A, in conjunction with the processor 304, can identify the plurality of item tags in an image. For example, the item identification module 308A, in conjunction with the processor 304, can utilize a machine learning model (such as a convolutional neural network) to identify item tags in the image.

To identify the items directly, the item identification module 308A, in conjunction with the processor 304, can train, maintain, and utilize a computer vision machine learning model to identify items on shelf units, which can be an object detection machine learning model. The computer vision machine learning model can include a you only look once (YOLO) machine learning model to identify the items and/or the item tags. A you only look once model can be a single-shot detector that uses a fully convolutional neural network (CNN) to process image data. Further details regarding you only look once models can be found in “You Only Look Once: Unified, Real-Time Object Detection” by J Redmon et al. 2015 (Arxiv reference arXiv: 1506.02640 [cs.CV]), which is herein incorporated by reference.

The map creation module 308B can include may comprise code or software, executable by the processor 304, for creating maps. The map creation module 308B, in conjunction with the processor 304, can generate maps based on items and/or item tags that are identified in image data of a shelf unit. The map creation module 308B, in conjunction with the processor 304, can generate nodes in the map that represent the identified items in the image data. The map creation module 308B, in conjunction with the processor 304, can generate edges between nodes in the map that represent spatial relationships between items in the image data.

For example, the map creation module 308B, in conjunction with the processor 304, can generate a first node in the map that represents a first item in the image data. The map creation module 308B, in conjunction with the processor 304, can generate a second node in the map that represents a second item in the image data. The map creation module 308B, in conjunction with the processor 304, can determine an edge between the first node and the second node that represents a vector between the first item and the second item. The vector can indicate a distance and a direction between the first item and the second item.

The map comparison module 308C can include may comprise code or software, executable by the processor 304, for comparing maps. The map comparison module 308C, in conjunction with the processor 304, can determine differences between two maps. The map comparison module 308C, in conjunction with the processor 304, can compare the nodes that are included in each map to determine if one or more nodes have been added or removed from a previous map to a current map. The map comparison module 308C, in conjunction with the processor 304, can compare edges that occur between the same nodes in different maps. For example, the map comparison module 308C, in conjunction with the processor 304, can compare a first edge between a first node and a second node in a previous map to a second edge between the first node and the second node in a current map. The map comparison module 308C, in conjunction with the processor 304, can compare the vector values of the edges.

Each node in a map can represent an item or an item tag on a shelf unit. A node can include data about the item and/or the item tag. A node can include a node identifier (e.g., a universally unique identifier (UUID)) that represents a spatial entity. A node can include an item identifier (e.g., a primary item identifier) that identifies the item itself and can correspond to a confidence value that indicates the accuracy of the item identifier for the node. The node can also include a list of one or more candidate item identifiers that include potential item identifiers with corresponding confidence values. The node can include references to one or more edges that connect to other nodes in the map. The node can include a clustering key that can be used to group nodes together. The clustering key can be a value that represents similar nodes. The clustering key can represent nodes that are similar and share an aisle number. The node can also include further data such as raw images of the item and/or item tag, an availability of the item, a category of the item, etc.

Each edge in a map can represent a connection between two items or item tags on a shelf unit. An edge can indicate a spatial distance and direction between two items or item tags. The edge can include a source node identifier and a destination node identifier that identify the two nodes that are related to the edge. The edge can include a vector (e.g., [x, y]) that points from the source node to the destination node and can represent a distance between the two nodes on the shelf unit or in the image.

The network interface 306 may include an interface that can allow the image analysis computer 208 to communicate with external computers. The network interface 306 may enable the image analysis computer 208 to communicate data to and from another device (e.g., the image database 206, the item information database 210, the map database 212, etc.). Some examples of the network interface 306 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 306 may include Wi-Fi™. Data transferred via the network interface 306 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 306 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

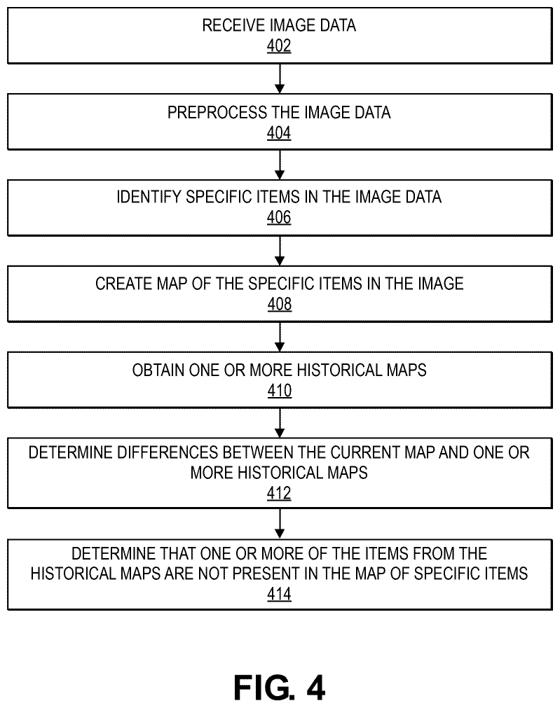

FIG. 4 shows a flowchart of an item tag modification method according to embodiments. The method illustrated in reference to FIG. 4 will be described in the context of a user, who operates a user device, obtaining an image of a shelf unit at a service provider location. The image data for the image can be provided to the image analysis computer 208 for processing. The image analysis computer 208 can create a new map that encodes data from the shelf unit regarding which specific items are on the shelf at particular locations. The image analysis computer 208 can determine whether or not any of the items have been absent from the shelf unit, thus indicating that the items have been discontinued, moved, or other reason for being missing from the shelf unit. The image analysis computer 208 can also identify that a new items have been added to the shelf units.

Prior to step 402, a user device can obtain image data of a shelf unit at a service provider location. The user device can also obtain additional data that can identify the shelf unit in the service provider location, the service provider location, and the service provider. For example, the user device can obtain a shelf unit identifier or an aisle identifier (e.g., an aisle number in a store), a service provider location identifier (e.g., a store number, an address, etc.), and a service provider identifier (e.g., a service provider name, a service provider identifying number, etc.). The user device can provide the image data along with the additional data to the central server computer 102 for storage in the image database 206. The central server computer 102 can store the image data and the additional data in association with one another in the image database 206.

As an illustrative example, the user device 202 can be operated by a transporter that has arrived at the service provider location. In some embodiments, the user device 202 and a central server computer in communication with the user device 202 can determine that the user device 202 has entered the service provider location using a global positioning system (GPS) or other location identification system. In response to the determination that the user device 202 has entered the service provider location, the user device 202 can display a scan shelf unit message on a display of the user device 202 to the transporter. The scan shelf unit message can request that the transporter scan a particular shelf unit at the service provider location. The shelf unit can include an entire shelf that holds items, or a portion of a shelf with items. The transporter can utilize a camera in the user device 202 to capture an image of the indicated shelf unit.

In some embodiments, the user device 202 can include a delivery application that can allow end users to select items for delivery from a service provider location to an end user location via a transporter. The delivery application can notify, via user devices, transporters to capture images.

At step 402, the image analysis computer 208 can receive image data from the image database 206. The image analysis computer 208 can obtain image data of an image of a shelf unit with specific items and item tags comprising machine readable codes (e.g., barcodes, QR code, etc.) adjacent to the specific items. The image analysis computer 208 can also obtain the additional data that is stored in association with the image data.

In some embodiments, the image analysis computer 208 can generate an image database query request message that requests image data and additional data from the image database 206. The image database 206 can generate an image database query response message that includes the image data and additional data. In some embodiments, the additional data can include a shelf unit identifier, a service provider location identifier, and a service provider identifier. The image database 206 can provide the image database query response message to the image analysis computer 208.

At step 404, after obtaining the image data, the image analysis computer 208 can perform data preprocessing on the image data. The image analysis computer 208 can modify the image data such that the image data can later be more effectively processed. The image analysis computer 208 can perform any type of image preprocessing on the image data. For example, the image analysis computer 208 can resize the image data, grayscale the image data, perform noise reduction on the image data, normalize the image data, perform binarization on the image data, enhance the image data's contrast, etc.

The image analysis computer 208 can resize image data to a uniform size such that later processes can utilize a standardized image data input size. In some embodiments, resizing (e.g., scaling) can aid in reducing the number of pixels from an image. Reducing the number of pixels can provide for the advantage of reducing computation time in later processes. Resizing can also aid with zooming in on images.

The image analysis computer 208 can grayscale the image data. Gray scaling can include converting color images to grayscale, which can simplify the image data and reduce computational needs for some algorithms.

The image analysis computer 208 can perform noise reduction on the image data. The image analysis computer 208 can apply smoothing, blurring, and filtering techniques to the image data to remove unwanted noise from images. Example noise reduction techniques can include using a Gaussian blur and a median blur.

The image analysis computer 208 can normalize the image data. During normalization, the image analysis computer 208 can adjusts the intensity values of the pixels in the image data to a desired range (e.g., between 0 and 1).

The image analysis computer 208 can perform binarization on the image data. Binarization can include converting a grayscale image to a black and white by thresholding each pixel to a value of 0 or 1.

The image analysis computer 208 can enhance the image data's contrast by evaluating a histogram of the image data's pixels. The image analysis computer 208 can adjust the contrast of the image data using histogram equalization.

In some embodiments, during or after image data preprocessing, the image analysis computer 208 can obtain the item tag data from the image data. The image analysis computer 208 can identify the item tags in the image data. The image analysis computer 208 can extract information (e.g., item name, machine readable code, price, etc.) from the item tag in the image data. For example, the image analysis computer 208 can identify item tags in the image data using a machine learning model (e.g., a convolutional neural network), or other process, to identify item tags in images or other suitable item tag determination method. The image analysis computer 208 can extract data from the item tags in the image data. For example, the image analysis computer 208 can extract item data such as a name, a price, a promotion, a price per unit, etc. from the item tag. The image analysis computer 208 can also extract a machine readable code from the item tag, where the machine readable code identifies the item and can indicate information about the item. For example, the image analysis computer 208 can determine additional information for each item based on the machine readable codes on the item tags, where the additional information includes an item identifier.

In some embodiments, the image analysis computer 208 can normalize and rectify the scale of the image data such that two images of the same shelf unit can utilize a similar coordinate system to indicate up, down, left, and right on the shelf unit as well as a similar scale. The image analysis computer 208 can normalize the scale of the image data such that the image data has a similar scale as previous image data. For example, the image analysis computer 208 can obtain an average size of item tags in a current image and in a previous reference image. The image analysis computer 208 can scale the coordinates of the current image such that the average size of item tags in the current image matches the average size of item tags in the previous reference image. In some embodiments, the image analysis computer 208 can scale the image data based on the width of the item tags, since the width of the item tags can be consistent at a service provider location. The image analysis computer 208 can rectify the skew of the image data using a matrix transformation to compensate for roll, pitch, and yaw changes between images.

At step 406, after preprocessing the image data, the image analysis computer 208 can identify specific items in the image data. The image analysis computer 208 can identify the specific items in the image data using a machine learning model that is trained to identify items in images. For example, the image analysis computer 208 can utilize a you only look once (YOLO) model to identify items in an image.

At step 408, after identifying the items, the image analysis computer 208 can create a map of the specific items in the image. The image analysis computer 208 can generate any suitable data structure that is a map that indicates relations between the specific items on the shelf unit. For example, the map can be a graph comprising a plurality of nodes and a plurality of edges. Each node can indicate an item or item tag in the image. Each edge can indicate a vector that points between neighboring items or item tags in the image. The image analysis computer 208 can determine nodes and edges for the map.

The image analysis computer 208 can determine nodes for the map. The image analysis computer 208 can determine the nodes to include in the map based on the identified items in the image data. Each identified item can correspond to a node in the map. The image analysis computer 208 can iterate through each identified item and can generate a node in the map that represents the identified item.

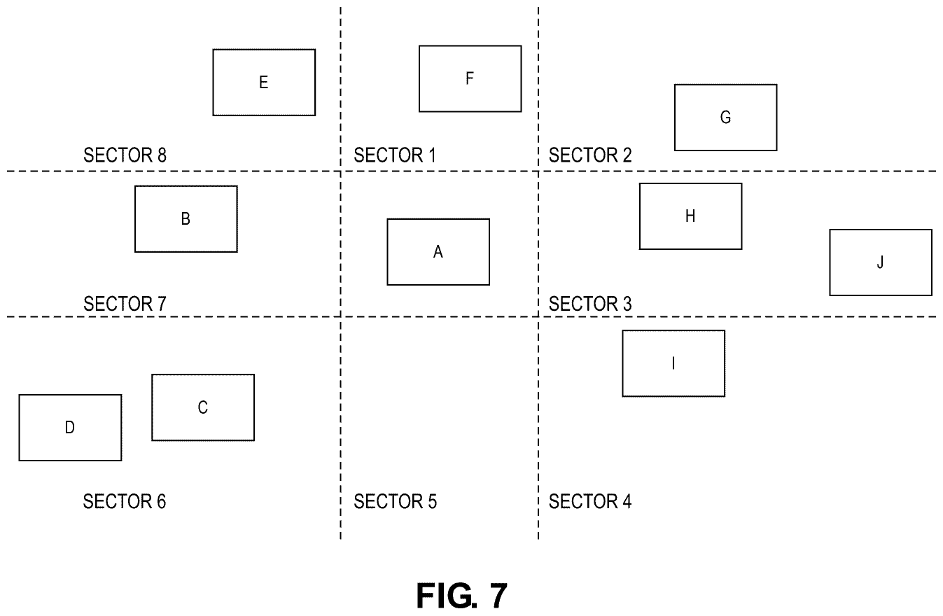

The image analysis computer 208 can determine edges for the map using edge feature extraction. The image analysis computer 208 can determine edges that represent a spatial distance between two items in the image data. The image analysis computer 208 can determine the edges as described in reference to FIG. 7.

For example, the image analysis computer 208 can generate a first node for a first identified item in the image data and can generate a second node for a second identified item in the image data. The image analysis computer 208 can evaluate the image data to determine a distance and direction between the first identified item and the second identified item in the image data. The distance between the first identified item and the second identified item can be a distance between a center point of each identified item in the image data. The direction can be indicated as a unit vector that points from the first identified item to the second identified item. The direction and the distance can be the edge between the first node and the second node.

In some embodiments, the map can be stored as one or more tensors. For example, a map can be stored as an adjacency matrix, an incidence matrix, a degree matrix, item identifier vectors, and/or any other suitable data.

At step 410, after generating the current map, the image analysis computer 208 can obtain one or more historical maps from the image database 206. The one or more historical maps can relate to the current map. For example, the one or more historical maps can relate to the current map in that each of the maps depict a same shelf unit at a same service provider location.

The image analysis computer 208 can identify the one or more historical maps from the image database 206 based on a service provider identifier and a service provider location identifier, such that all compared maps are from the same location. The image analysis computer 208 can also identify the one or more historical maps from the image database 206 based on an aisle number or other shelf unit identifying value, such that all compared maps represent the same shelf unit(s).

At step 412, the image analysis computer 208 can compare the current map to one or more historical maps of historical items from past images. The historical maps can be previously generated maps that correspond to the same shelf unit as the created map. The image analysis computer 208 can determine differences between the map of specific items and the one or more historical maps. The image analysis computer 208 can determine the differences between the data structures of each map.

At step 414, after determining the differences between the map of specific items and the one or more historical maps, the image analysis computer 208 can determine that one or more of the items from the one or more historical maps are not present in the map of specific items.

For example, the image analysis computer 208 can determine that a particular item is included in a historical map, but is not included in the newly created map. As another example, the image analysis computer 208 can determine that the relationships between particular items have changed in the newly created map compared to the historical map, thus indicating that items have moved on the shelf unit in relation to one another.

In some embodiments, the image analysis computer 208 can track an item being missing from maps over time. The image analysis computer 208 can compare the length of time (based on timestamps associated with the maps) that the item has been missing from a location on a shelf unit to a threshold amount of time. If the item has been missing for more that the threshold amount of time, then the image analysis computer 208 can flag the item as being removed from the shelf unit.

The image analysis computer 208 can store the identified differences in a database. The image analysis computer 208 can generate an item information data entry that indicates a change in the current map from one or more historical maps. For example, the item information data entry can indicate that a particular item is no longer present in the current map, but was present in one or more historical maps. The image analysis computer 208 can store the item information data entry into the item information database 210. The item information data entry can also include identifying information. The item information data entry can include identification data such as a service provider identifier, a service provider location identifier, a shelf unit identifier, a timestamp of the map in which the change is detected, a item identifier, etc.

At some point in time after the image analysis computer 208 stores the item information data entry into the item information database 210, the central server computer 102 can update an item listing in a delivery application based on the item information data entry. The central server computer 102 can be notified by the item information database 210 of changes made to the database. The central server computer 102 can obtain the item information data entry. The central server computer 102 can determine an item listing in the delivery application that matches the item involved in the change from the item information data entry. The central server computer 102 can determine the item listing using the identification data in the item information data entry. In some cases, there may not be a corresponding item listing for the item if the item is a new item. The central server computer 102 can update the item listing based on the detected change. The central server computer 102 can remove the item listing, create a new item listing, or modify the item listing (e.g., change a quantity, change a shelf unit identifier, etc.).

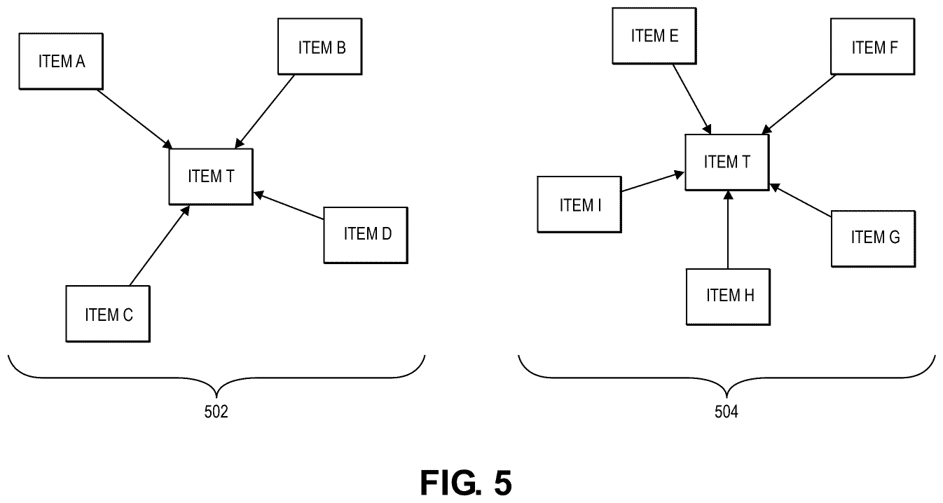

FIGS. 5-7 will be described in reference determining and comparing maps of items from image data. In some cases, it may not be enough to know that a node representing an item (e.g., an item's identifier) has been added to or removed from a shelf unit. It can be advantageous to know where the item was added or removed at the service provider location (e.g., store).

An item's location inside a store can be inferred from its context (e.g., neighboring items). A cluster of unique items can identify a location in a store on a shelf unit. For a duplicate item with multiple locations, each duplicate item will have different sets of neighbors in those locations. Thus, it is possible to deduplicate items by location. Such deduplication can aid in inventory management.

FIG. 5 shows block diagram illustrating maps according to embodiments. FIG. 5 illustrates two maps that correspond to two different shelf units a service provider location. FIG. 5 includes a first map 502 and a second map 504. The maps in FIG. 5 illustrate a situation in which a particular type of item is located at two different positions at a service provider location. For example, an item can be located on two different shelf units.

Each map can include items, which can be represented using item identifiers, as nodes and vectors pointing from a bounding box of the current item to its neighboring item(s) as edges. A set of items and vectors (e.g., nodes and edges) can determine neighbor context.

The first map 502 can be of an item T at a first location. The second map 504 can be of an item T at a second location. The item T can be the same item (e.g., a same resource), but a different instance of the item in the store.

The image analysis computer 208 can identify that there are two different instances of the item T at the service provider location. For example, the image analysis computer 208 can identify that the item T is present in the first map 502. The image analysis computer 208 can identify that the item T is present in the second map 504. The image analysis computer 208 can evaluate the two maps to determine neighboring items around the item T.

In the first map 502, the image analysis computer 208 can determine that item T is surrounded by item A, item B, item C, and item D. In the second map, the image analysis computer 208 can determine that the item T is surrounded by item E, item F, item G, item H, and item I.

The image analysis computer 208 can verify that the two maps are not the same map and redundant to one another based on the differences of surrounding items that surround the item T in both maps.

For example, the image analysis computer 208 can determine which nodes are connected by edges to the item T in each map. The image analysis computer 208 can compare the list of determined nodes (e.g., neighboring node) between each map. Differences between the two lists of determined nodes can indicate that the two instances of item T are at different shelf unit locations and are not actually the same item in two different overlapping images.

Using vectors as the edges has the advantage of allowing tolerances. For example, there might be slight variations in the determination of the edge vectors due to any remaining image skew bias after image normalization. The image analysis computer 208 can compare vector cosine similarity and allow for some margin of measurement error.

In some embodiments, for each item, the image analysis computer 208 can build up a context (e.g., neighboring nodes and edge vectors) by looking at historic shelf tag scan images and can store the context for future use. Doing so can provide high confidence of context. The image analysis computer 208 can infer what item should be at a location by triangulating the edge vectors using the context (e.g., from a nodes neighbors).

As an illustrative example, the image analysis computer 208 can receive first image data of a first image of a first shelf unit with first specific items and first item tags comprising machine readable codes adjacent to the first specific items. The image analysis computer 208 can identify the first specific items in the first image. The image analysis computer 208 can create a first current map based on the first specific items in the first image.

After analyzing the first image and creating the first current map, the image analysis computer 208 can then receive second image data of a second image of a second shelf unit with second specific items and second item tags comprising machine readable codes adjacent to the second specific items. The image analysis computer can identify the second specific items in the second image. The image analysis computer 208 can create a second current map based on the second specific items in the second image.

The image analysis computer 208 can determine differences between the second current map and the first current map. The image analysis computer 208 can determine whether or not any of the first specific items are the same as the second specific items. If any of the first specific items the first image are the same items as the second specific items in the second image, then the image analysis computer 208 can deduplicate first specific items that match second specific items in an item information database. For example, the item information database can have two entries for the same item, since it is possible that the item is at two different locations in the store (e.g., the item can be in an aisle and on an endcap at the end of an aisle). The image analysis computer 208 can identify the deduplicated data entry for the same item data and remove the duplicate and/or combine the two data entries for the item into a single data entry in the item information database.

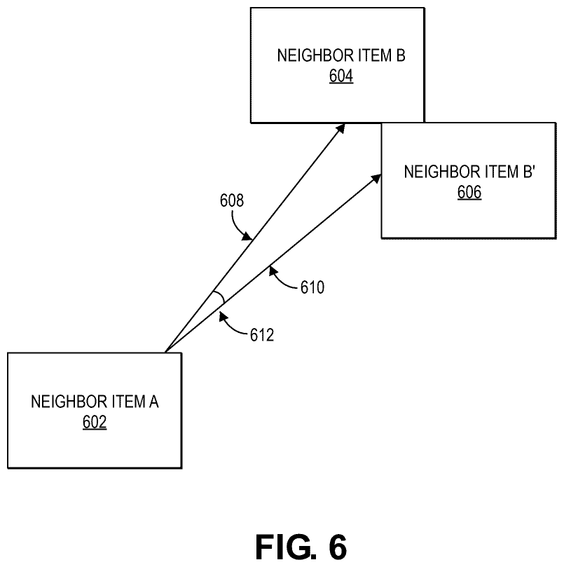

FIG. 6 shows a block diagram illustrating a map with a neighbor item and target items according to embodiments. FIG. 6 includes a neighbor item A 602, a target item B 604, and a target item B′ 606. FIG. 6 illustrates a difference in measurement of an edge vector for a target item in two different maps, which are overlayed in FIG. 6. The target item B 604 can be included in a first map and the target item B′ 606 can be included in a second map that was created after the first map.

The image analysis computer 208 can determine a historical edge 608 between the target item B 604 and the neighbor item A 602 when creating the first map. The image analysis computer 208 can determine a current edge 610 between the target item B′ 606 and the neighbor item A 602 when creating the second map.

The image analysis computer 208 can determine that the historical edge 608 in the first map is different than the current edge 610 in the second map. The image analysis computer 208 can determine an angle 612 between the historical edge 608 and the current edge 610.

The image analysis computer 208 determine whether or not the target item B′ 606 is within a threshold margin of difference from the target item B 604 to be considered as the same item based on the historical edge 608, the current edge 610, and angle 612. For example, the image analysis computer 208 can perform cosine similarity to determine the similarity of the two edges.

If the historical edge 608 and the current edge 610 are similar compared to a similarity threshold, then the image analysis computer 208 can identify the target item B′ 606 as being the same item as the target item B 604. If the historical edge 608 and the current edge 610 are not similar compared to the similarity threshold, then the image analysis computer 208 can identify the target item B′ 606 as being moved from the location of the target item B 604 to the location of the target item B′ 606.

As an illustrative example, the image analysis computer 208 can identify a first target node in a current map. The first target node can represent the target item B′ 606. The image analysis computer 208 can identify a second target node in a historical map of one or more historical maps. The second target node can represent the target item B 604. The second target node and the first target node can be identified as having a same item identifier. For example, both the target item B 604 and the target item B′ 606 can be identified as being a box of cereal of a same brand, which can be identified using an item identifier. The item identifier can be a number or a name that represents the identified item. The image analysis computer 208 can determine one or more one or more first edges (e.g., including the current edge 610) that connect the first target node to first neighboring nodes (e.g., represented as the neighbor item A 602) in the current map. The image analysis computer 208 can determine one or more second edges (e.g., including the historical edge 608) that connect the second target node to second neighboring nodes (e.g., represented as the neighbor item A 602) in the historical map. The image analysis computer 208 can compare the one or more first edges to the one or more second edges to obtain a similarity score that indicates a similarity of a neighborhood for the first target node and the second target node. Based on the similarity score, the image analysis computer 208 can determine whether or not the first target node and the second target node indicate an item that is at the same location or indicate an item that has moved on the shelf unit.

FIG. 7 shows a block diagram illustrating edge feature extraction according to embodiments. Each edge in a map can indicate neighboring item information. Performing edge feature extraction can include determining neighboring items and distances from a target item.

The image analysis computer 208 can iterate through every item in the image data to determine edges. The item that the image analysis computer 208 is currently evaluating can be referred to as a target item.

For each item in the image data (e.g., for each target item), the image analysis computer 208 can determine neighboring sectors. For example, the current target item in FIG. 7 can be the item A. The image analysis computer 208 can identify a plurality of sectors around the target item. The image analysis computer 208 can identify any number of sectors (e.g., 3, 4, 6, 8, 10, 12, 20 sectors). For example, FIG. 7 illustrates eight neighboring sectors, numbered 1 through 8, that surround the target item of item A. The image analysis computer 208 can determine a plurality of sectors for the specific item in the image.

For each sector of the plurality of sectors, the image analysis computer 208 can identify neighboring item(s). The neighboring item(s) can include a closest item as well as a closest item with a resolvable machine readable code (e.g., this can yield one or two items) in the image data.

A resolvable machine readable code can include an identifiable machine readable code in the image data that has a high enough resolution to accurately identify an item associated with the resolvable machine readable code.

For example, for each sector of the plurality of sectors, the image analysis computer 208 can identify zero, one, or two neighboring items in the sector.

After identifying the neighboring items in the plurality of sectors, the image analysis computer 208 can calculate a vector representation of each identified neighboring item to the target item (e.g., item A). For each neighboring item in the sector, the image analysis computer 208 can generate an edge that indicates a distance and a direction between the specific item and the neighboring item.

As an illustrative example, the image analysis computer 208 can generate a feature table, as show in Table 1. Table 1 includes a portion of a matrix representation of the map illustrated in FIG. 7.

For sector 1, the image analysis computer 208 can identify all items in sector 1. The image analysis computer 208 can determine the closest item in sector 1.

The closest item in sector 1 can be item F. The image analysis computer can determine the closest item in sector 1 that corresponds to a resolvable machine readable code. The closest item with a resolvable machine readable code in sector 1 can be item F. As such, for sector 1, the image analysis computer 208 can identify a neighboring item of item F.

For sector 2, the image analysis computer 208 can identify all items in sector 2. The image analysis computer 208 can determine the closest item in sector 2. The closest item in sector 2 can be item G. The image analysis computer can determine the closest item in sector 2 that corresponds to a resolvable machine readable code. There may be no item with a resolvable machine readable code in sector 2. As such, for sector 2, the image analysis computer 208 can identify a neighboring item of item G.

For sector 3, the image analysis computer 208 can identify all items in sector 3. The image analysis computer 208 can determine the closest item in sector 3. The closest item in sector 3 can be item H. The image analysis computer can determine the closest item in sector 3 that corresponds to a resolvable machine readable code. The closest item with a resolvable machine readable code in sector 3 can be item J. As such, for sector 3, the image analysis computer 208 can identify neighboring items of item H and item J.

For sector 4, the image analysis computer 208 can identify all items in sector 4. The image analysis computer 208 can determine the closest item in sector 4. The closest item in sector 4 can be item I. The image analysis computer can determine the closest item in sector 4 that corresponds to a resolvable machine readable code. The closest item with a resolvable machine readable code in sector 4 can be item I. As such, for sector 4, the image analysis computer 208 can identify a neighboring item of item I.

For sector 5, the image analysis computer 208 can identify all items in sector 5. The image analysis computer 208 can determine the closest item and the closest item that corresponds to a resolvable machine readable code in sector 5. However, there may be no items in sector 5. The image analysis computer 208 can determine that there are no neighboring items in sector 5.

For sector 6, the image analysis computer 208 can identify all items in sector 6. The image analysis computer 208 can determine the closest item in sector 6. The closest item in sector 6 can be item C. The image analysis computer can determine the closest item in sector 6 that corresponds to a resolvable machine readable code. The closest item with a resolvable machine readable code in sector 6 can be item D. As such, for sector 6, the image analysis computer 208 can identify neighboring items of item C and item D.

For sector 7, the image analysis computer 208 can identify all items in sector 7. The image analysis computer 208 can determine the closest item in sector 7. The closest item in sector 7 can be item B. The image analysis computer can determine the closest item in sector 7 that corresponds to a resolvable machine readable code. The closest item with a resolvable machine readable code in sector 7 can be item B. As such, for sector 7, the image analysis computer 208 can identify a neighboring item of item B.

For sector 8, the image analysis computer 208 can identify all items in sector 8. The image analysis computer 208 can determine the closest item in sector 8. The closest item in sector 8 can be item E. The image analysis computer can determine the closest item in sector 8 that corresponds to a resolvable machine readable code. The closest item with a resolvable machine readable code in sector 8 can be item E. As such, for sector 8, the image analysis computer 208 can identify a neighboring item of item E.

The image analysis computer 208 can generate a vector that represents the distance and direction between the target item A and each neighboring item. The vector can be the edge between the two nodes. Example vectors are included in Table 1, below.

TABLE 1
feature table

| Src Node | Dst Node | Sector | Vector (x, y) |
|---|---|---|---|
| A | F | 1 | (2, 10) |
| A | G | 2 | (25, 8) |
| A | H | 3 | (23, 2) |
| A | J | 3 | (31, −1) |
| A | I | 4 | (19, −8) |
| A | D | 6 | (−19, −15) |
| A | C | 6 | (−30, −17) |
| A | B | 7 | (−20, 2) |
| A | E | 8 | (−8, 10) |

The above process is illustrated for node A, but is repeated for each of the nodes in a similar manner. In this way, the analysis computer 208 can efficiently and accurately determine a map (or graph) of an entire shelf unit.

The image analysis computer 208 can create a map for each image of shelf units at a service provider location. A single map can be referred to as an image view of the items. The image analysis computer 208 can combine all images taken during a scanning session together to obtain a session view, which contains a plurality of image views. The image analysis computer 208 can combine multiple session views (e.g., from different days) for a service provider location to determine a store view. A store view can be versioned by date and constituent session views. The image analysis computer 208 can evaluate the historical maps in the store view in different session views and image views.

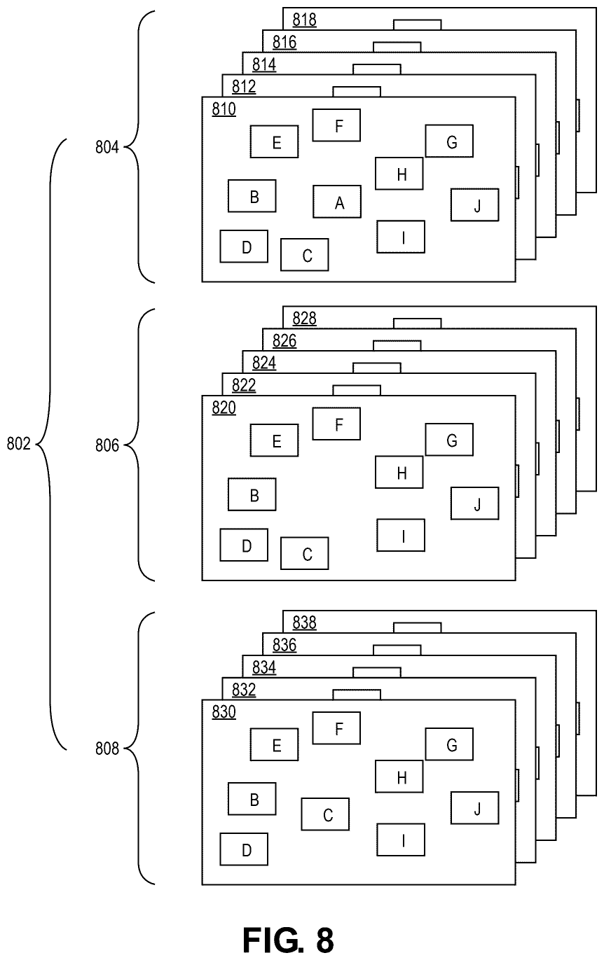

For each service provider and service provider location, the image analysis computer 208 can receive hundreds of images, each with a plurality of item tags. The image analysis computer 208 can utilize the tiered data structure illustrated in FIG. 8 to track and leverage the imaging results across multiple scan sessions/days to accurately adjust a tracked inventory level.

FIG. 8 shows a diagram illustrating historical maps according to embodiments. FIG. 8 includes a store view 802, a first session view 804, a second session view 806, and a third session view 808. The store view 802 can include all historical maps that relate to the service provider location. The store view 802 can be stored in a database in association with a service provider location identifier (e.g., a store identifier, an address, etc.).

The first session view 804, the second session view 806, and the third session view 808 can each include a plurality of historical maps that were generated from images taken during a particular image capturing session. The image capturing session can be associated with the session view. For example, the first session view 804 can include maps generated from images captured during a first shelf unit imaging session. The second session view 806 can include maps generated from images captured during a second shelf unit imaging session. The third session view 808 can include maps generated from images captured during a third shelf unit imaging session.

The first session view 804 can include a plurality of historical maps including maps 810, 812, 814, 816, and 818. The second session view 806 can include a plurality of historical maps including maps 820, 822, 824, 826, and 828. The third session view 808 can include a plurality of historical maps including maps 830, 832, 834, 836, and 838.

As an example, during the first session view 804, the image analysis computer 208 can determine that an item A is present in the map 810 for a particular shelf unit at a service provider location. During the second session view 806, the image analysis computer 208 can determine that the item A is not present in the map 820 for the shelf unit. During the third session view 808, the image analysis computer 208 can determine that the item C has moved to a different location on the shelf unit.

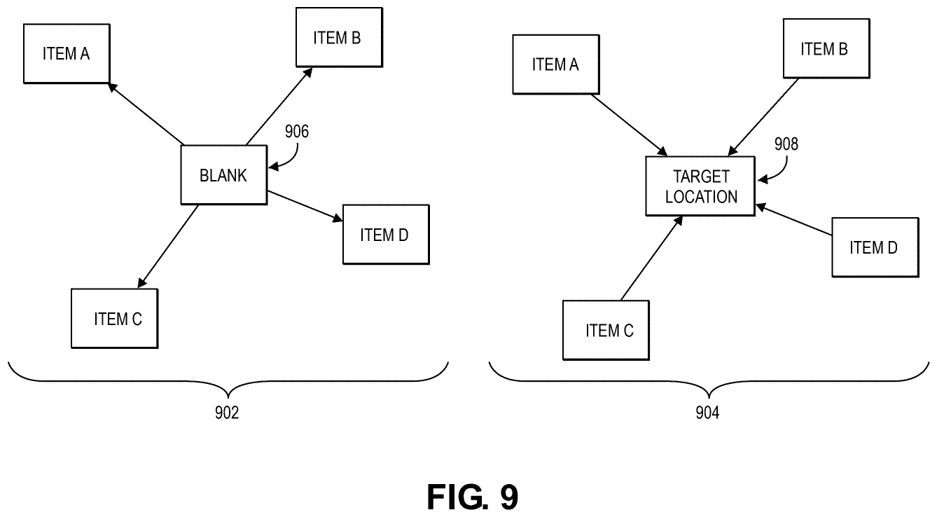

FIG. 9 shows maps illustrating identifying an item tag being removed from a shelf unit according to embodiments. The image analysis computer 208 can perform item change identification. FIG. 9 includes a current map 902 and a historical map 904. The current map 902 and the historical map 904 can be created by the image analysis computer 208 from first image data and second image data, respectively. The current image data and the historical image data can include images of a same shelf unit at a service provider location at different times. For example, the historical map 904 can be created one week prior to the current map 902.

An item and a corresponding item tag, which includes a machine readable code, can historically be located on a shelf unit. The item and the item tag may be removed from the shelf unit at a point in time. For example, the item tag can be removed from the shelf unit between creation of the current map 902 and creation of the historical map 904.

The image analysis computer 208 can generate the current map 902 using current image data and can compare the current map 902 with the historical map 904. The image analysis computer 208 can identify that there is a missing item that is not included in the current map 902, but was included in the historical map 904. The image analysis computer 208 can add a blank node 906 into the current map 902 as a placeholder for the removed item to aid in the determination and verification of what item was removed.

The image analysis computer 208 can determine the neighbors (e.g., the context) of the blank node 906 in the current map 902. The image analysis computer 208 can determine the edges between the blank node 906 and the neighboring nodes of item A, item B, item C, and item D.

After determining the vectors for the edges for the blank node 906, the image analysis computer 208 can use the vectors and the historical map to determine the missing item. The image analysis computer 208 can use the vectors from the current map 902 to determine a target location 908 in the historical map 904. The image analysis computer 208 can determine what item and node is located at the location in the historical map 904 based on the vector location. The image analysis computer 208 can determine that, for example, an item X (not shown) is located at the target location 908 which corresponds to the blank node 906 location. As such, the image analysis computer 208 can determine that the item X has been removed from the shelf unit based on the comparison of the current map 902 to the historical map 904.

In some embodiments, the image analysis computer 208 can determine a consensus from querying the store view (e.g., determine consensus of an item's location from a plurality of historical maps) can determine the previous state of the item and item tag. Comparing the previous state to the current state of the item and item tag in the current map 902 can allow the image analysis computer 208 to detect changes. The image analysis computer 208 can then output detected change events.

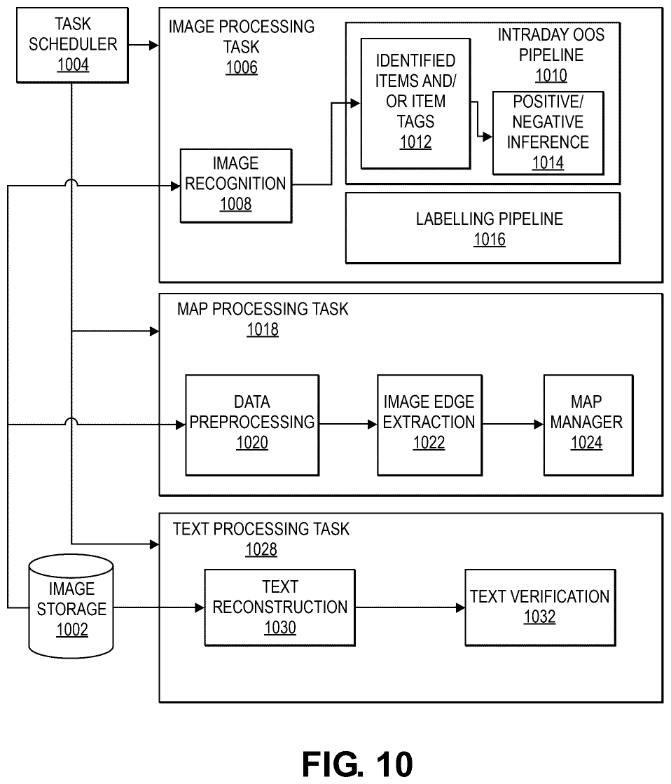

FIG. 10 shows a block diagram illustrating a data processing system according to embodiments. FIG. 10 includes an image storage 1002, a task scheduler 1004, an image processing task 1006, a map processing task 1018, and a text processing task 1028.

The image storage 1002 can store image data. The image storage can be the image database 206 of FIG. 2. The image storage 1002 can store image data obtained from a plurality of user devices, which can be operated by transporters, end users, or other users.

The task scheduler 1004 can schedule tasks for the image processing task 1006, the map processing task 1018, and the text processing task 1028. The task scheduler 1004 can schedule tasks based on when images are stored in the image storage 1002, how many unprocessed images are in the image storage 1002, current load balances of the image analysis computer 208, etc.

The image processing task 1006 can identifying items and/or item tags in image data. The image processing task 1006 can include image recognition 1008, an intraday OOS (out of stock) pipeline 1010 including identified items and/or item tags 1012 and a positive/negative inference 1014, and a labelling pipeline 1016.

During the image processing task 1006, the image analysis computer 208 can perform the image recognition 1008 process to identify items and/or item tags in an image. The image recognition 1008 process can include a machine learning model that is trained to identify items and/or item tags in image data. The image recognition 1008 process can output item bounding boxes, item tag bounding boxes, associations between items and item tags, or other information relating to identifying the items and/or the item tags.

During the intraday OOS pipeline 1010, the image analysis computer 208 can obtain the identified items and/or item tags 1012 from the image recognition 1008 process. The image analysis computer 208 can perform a positive/negative inference 1014 process on the identified items and/or item tags to determine if the identification is a false positive, for example.

During positive/negative inference 1014, the image analysis computer 208 can evaluate the image data and the identified items and/or item tags to determine whether or not the identified items and/or item tags are accurate. Further, during positive/negative inference 1014, the image analysis computer 208 can evaluate whether or not sections of a shelf unit were not imaged.

Embodiments solve the technical problem of false positives of identified items occurring in the image data. Long term out of stock detection can work by finding the difference between new map data and baseline map data. For incumbent detection, full store maps can be compared to recorded inventory. For incremental detection, new maps can be compared to historical maps. Thus, anytime an item is not found in a new map, when in reality the item should be found, a false positive event is created. Example false positive types can include area not imaged, section not imaged, item tag recognition and barcode read issues, and structural issues.

Using the labelling pipeline 1016, the image analysis computer 208 can add labels to the image data based on the identified items and/or item tags. The labels can indicate what items are in the image and/or where the items are located in the image. The labelling pipeline 1016 can aid the image recognition 1008 process, which includes a machine learning model, to identify items and item tags in images.

The map processing task 1018 can include data preprocessing 1020, image edge extraction 1022, and a map manager 1024. During the map processing task 1018, the image analysis computer 208 can preprocess image data from the image storage 1002 as described herein.

The image analysis computer 208 can generate a map by creating nodes in the map based on identified items and can perform image edge extraction 1022 to determine edges between the nodes.

After generating the map by creating the nodes and edges, the image analysis computer 208 can utilize a map manager 1024 to manage the created maps. The map manager 1024 can store newly created maps in a map database in association with map identifying data. The map manager 1024 can also obtain historical maps from the map database for the image analysis computer 208 to compare to a current map.

The text processing task 1028 can include text reconstruction 1030 and text verification 1032. During the text processing task 1028, the image analysis computer 208 can determine text in an item tag on the shelf unit from the image data. During text reconstruction 1030, the image analysis computer 208 can reconstruct text from an identified item tag that is in the image data. The text reconstruction 1030 can include rectifying a portion of the image data that includes the identified item tag and determining text using an optical character recognition (OCR) process.

After performing text reconstruction 1030, the image processing computer can perform text verification 1032. The image analysis computer 208 can verify that the determined text is accurate. For example, the image analysis computer 208 can compare words from the determined text to a list of dictionary words to determine if the determined words exist or if the text reconstruction 1030 process introduced spelling errors. The image analysis computer 208 can perform any suitable text verification process to verify the text determined from the image data.

In some embodiments, every shelf unit at a service provider location can be imaged during an imaging session (e.g., referred to as a store scan). Following each store scan the image analysis computer 208 can create a summary of the imaging session. The summary can provide high level insights into what items are scanned, their categories, and total count. The image analysis computer 208 can generate any data related to the image data, the service provider location, the service provider, the shelf unit(s), the items, the item tags, etc.

For example, the image analysis computer 208 can generate a scan session identifier that can be a unique identifier that identifies a scan session from task assignment to completion. The image analysis computer 208 can generate a scan session creation date that can be a date time string of the last event for the scan (e.g., YYYY-MM-DD hh:mm:ss). The image analysis computer 208 can generate a scan type identifier that indicates a type of scan such as a full scan or a partial scan. The image analysis computer 208 can generate a scan request metadata that can include a JSON string that describes the scan such as aisle counts, aisle numbers, categories of items scanned, etc.

In some embodiments, the image analysis computer 208 can have scan data requirements for an imaging session. For the scan data requirements, the image analysis computer 208 can set rules about items found for each scan. The scan data requirements can indicate a total number of unique items per full store scan, categories of items, and unique items per category in each full store scan, a total number of unique items scanned for aisle or categories scan, etc. The scan data requirements can be seeded empirically and then dynamically updated later.

The image analysis computer 208 can validate new images from a scan session. The image analysis computer 208 can check the new scan against the scan data requirement. For a full store scan, the image analysis computer 208 can ensure X number of unique items are found. For categories and/or aisle scans, the image analysis computer 208 can ensure Y% of items in the category is scanned.

In some embodiments, the image analysis computer 208 can obtain aisle information from the generated maps. After the aisle information is collected, the image analysis computer 208 can assign aisles in scan task assignment. The image analysis computer 208 can examine how many unique items per aisle were previously scanned. The image analysis computer 208 can ensure that acceptable new scans have at least Z% of unique items in previous scan. In some embodiments, only if new scan data satisfy criteria, does the image analysis computer 208 consider the scan to be usable for long term out of stock detection.

In some embodiments, the image analysis computer 208 can combine scan sessions if a particular period's worth of scans (e.g., one day's worth of scan) is less that a threshold amount (e.g., fewer than 5 images were captured, etc.). The image analysis computer 208 can combine two scan sessions, which are close enough together in time based on a threshold time difference, for long term out of stock detection. In some embodiments, a full scan of all shelf units at a service provider location can be performed at regular intervals (e.g., once per week, once per month, etc.). Incremental scans a few times a week can be utilized to provide more information in addition to the full scans.

In some embodiments, the image analysis computer 208 can have a deny/allow list. The deny/allow list can allow the image analysis computer 208 to override the image data to include entire categories of item that are high in confidence (e.g., with respect to scan quality), or exclude entire categories of items from actioning, if they are known to have low scan quality. For example, particular items may be more easily recognized that other items based on their physical appearance on the shelf units. If a particular type of item always provides low detection accuracy, then that type of item can be ignored in images when creating and utilizing maps.

Embodiments can display outputs from the image analysis computer 208 as alerts and in a dashboard. Embodiments can provide for a data dashboard that includes the accuracy of machine learning models (e.g., the item detection machine learning model, etc.) which includes data such as percentage of recognized barcode, percentage of recognized shelf tag, etc. The dashboard can also include machine learning model run time and can include what percentage of items needs to use an image based inference algorithm. Embodiments can provide for a task level dashboard that includes a total numbers of scans per day, total numbers of stores scanned per day, a user compliance according to scan schedule, a user compliance according to scan area (aisle location) or categories), a number of aisle/categories covered per scan, etc. Embodiments can provide for a system level dashboard that includes data for a front end and data for a back end. The data for the front end can include a number of crashes for the mobile application, etc. The data for the back end can include data loading time and failure/success rate, algorithm execution time and failure/success rate, report publishing failure/success rate, a total number of detection runs per day, API latency and failure/success rate, etc.

Embodiments of the disclosure have a number of technical advantages. For example, embodiments can detect changes in long term changes in items on shelf units using image data. Using image data, embodiments can determine that a specific item has been taken off of a service provider shelf for the long term. By identifying what items have been removed from the shelf units for the long term, more accurate lists of items can be provided to end users, so that the end users can select from in stock items when requesting item delivery from transporters. For example, delivery applications can be accurately updated to indicate that an item is no longer available, newly available, or can be found at a different location in the store.

Using images from many users to determine items on shelves at a service provider location that relate to long term out of stock items, new items, or moved items is faster than individually scanning every barcode in a store. Doing so can allow item listings to be more accurate and up to date. This solves the problem of an end user selecting to have an item delivered that is actually out of stock, but is not yet updated in the item inventory. This also solves the problem of an item being moved in the store, but the item listing still indicates the previous item location in the store, thus making it difficult for a transporter to find and obtain the item for delivery to the end user.

Embodiments further provide for the technical advantage processing item data faster than previous methods that used barcode scanners to track inventory levels. Embodiments provide for systems and methods that can capture and process 200 SKU (stock-keeping units) per minute. Embodiments allow for faster item determination than previous methods, which allows for item inventory levels to be updated faster.

Embodiments further provide for the technical advantage of higher accuracy since during neighbor edge detection, edges can be determined twice (e.g., once per end node for the edge). For example, an edge can be determined from node A to node B and then determined again from node B to node A. The edges can become more accurate due being determined more than once using different starting nodes. Determination of the edge more than once can reduce measurement error.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, image data of an image of a shelf unit with specific items and item tags comprising machine readable codes adjacent to the specific items;
identifying, by the computer, the specific items in the image;
creating, by the computer, a current map based on the specific items in the image;
determining, by the computer, differences between the current map and one or more historical maps of historical items from past images; and
determining, by the computer, that one or more of the items from the one or more historical maps are not present in the current map.

2. The method of claim 1, wherein identifying the specific items in the image comprises:
identifying, by the computer, the specific items in the image using an object detection machine learning model.

3. The method of claim 2, wherein the current map is a planogram.

4. The method of claim 1, wherein the specific items are determined based on the machine readable codes adjacent to the specific items.

5. The method of claim 1, wherein a user device captured the image data and provided the image data to a server computer, wherein the server computer stored the image data in an image database.

6. The method of claim 1, wherein the current map includes a graph, wherein the one or more historical maps include graphs, and wherein creating the current map comprises:
creating, by the computer, the graph comprising a plurality of nodes and a plurality of edges, wherein each node indicates a specific item or an item tag in the image data, and wherein each edge indicates a vector that points between neighboring items or item tags in the image data.

7. The method of claim 6, wherein determining differences between the current map and the one or more historical maps comprises:
comparing, by the computer, nodes and edges of the current map to nodes and edges of the one or more historical maps.

8. The method of claim 6, wherein determining differences between the current map and the one or more historical maps comprises:
identifying, by the computer, a first target node in the current map;
identifying, by the computer, a second target node in a historical map of the one or more historical maps, wherein the second target node and the first target node are identified as having a same item identifier;
determining, by the computer, one or more first edges that connect the first target node to first neighboring nodes in the current map;
determining, by the computer, one or more second edges that connect the second target node to second neighboring nodes in the historical map;
comparing, by the computer, the one or more first edges to the one or more second edges to obtain a similarity score that indicates a similarity of a neighborhood for the first target node and the second target node; and
based on the similarity score, determining, by the computer, whether or not the first target node and the second target node indicate an item that is at the same location or indicate an item that has moved on the shelf unit.

9. The method of claim 1, wherein creating the current map comprises:
iteratively determining, by the computer, a plurality of edges for each specific item in the image data.

10. The method of claim 9, wherein iteratively determining the plurality of edges for each specific item comprises:
determining, by the computer, a plurality of sectors for the specific item in the image;
for each sector of the plurality of sectors, identifying, by the computer, zero, one, or two neighboring items in the sector; and
for each neighboring item in the sector, generating, by the computer, an edge that indicates a distance and a direction between the specific item and the neighboring item.

11. The method of claim 10, wherein identifying zero, one, or two neighboring items in the sector comprises:
determining, by the computer, whether or not there is a closest item to the specific item in the sector; and
determining, by the computer, whether or not there is a closest item that is associated with a resolvable machine readable code in the image data to the specific item in the sector.

12. The method of claim 1 further comprising:
generating, by the computer, an item information data entry that indicates that the one or more of the items from the one or more historical maps are not present in the current map; and
storing, by the computer, the item information data entry into an item information database.

13. The method of claim 12, wherein a central server computer obtains the item information data entry from the item information database and updates an item listing in an application based on the item information data entry.

14. The method of claim 1, wherein the image data is received in an image database query response message, wherein the image database query response message includes the image data and additional data, wherein the additional data includes a shelf unit identifier, a service provider location identifier, and a service provider identifier, wherein the method further comprises:
generating, by the computer, an image database query request message that requests image data and additional data.

15. The method of claim 14, wherein the specific items in the image are identified using a machine learning model that is trained to identify items in image data.

16. A computer comprising:
a processor; and
a computer-readable medium coupled to the processor, the computer-readable medium comprising code executable by the processor for implementing a method comprising:
receiving image data of an image of a shelf unit with specific items and item tags comprising machine readable codes adjacent to the specific items;
identifying the specific items in the image;
creating a current map based on the specific items in the image;
determining differences between the current map and one or more historical maps of historical items from past images; and
determining that one or more of the items from the one or more historical maps are not present in the current map.

17. The computer of claim 16, wherein the method further comprises:
storing the current map in a map database in association with a shelf unit identifier, a service provider location identifier, and/or a service provider identifier.

18. The computer of claim 16, wherein the computer is an image analysis computer, wherein the current map is a first current map, the image data is first image data, the image is a first image, the specific items are first specific items, the item tags are first specific item tags, the shelf unit is a first shelf unit, and wherein the method further comprises:
receiving second image data of a second image of a second shelf unit with second specific items and second item tags comprising machine readable codes adjacent to the second specific items;
identifying the second specific items in the second image;
creating a second current map based on the second specific items in the second image;
determining differences between the second current map and the first current map; and
determining whether or not any of the first specific items are the same as the second specific items; and
deduplicating first specific items that match second specific items in an item information database.

19. A system comprising:
a central server computer;
an image database in communication with the central server computer; and
an image analysis computer in communication with the image database, the image analysis computer comprising:
a processor; and
a computer-readable medium coupled to the processor, the computer-readable medium comprising code executable by the processor for implementing a method comprising:
receiving image data of an image of a shelf unit with specific items and item tags comprising machine readable codes adjacent to the specific items;
identifying the specific items in the image;
creating a current map based on the specific items in the image;
determining differences between the current map and one or more historical maps of historical items from past images; and
determining that one or more of the items from the one or more historical maps are not present in the current map.

20. The system of claim 19, wherein the current map includes a graph, wherein the one or more historical maps include graphs, wherein the central server computer receives images from user devices that include end user devices and transporter user devices and stores the images in the image database, wherein the central server computer updates item listings in a delivery application based on one or more item information data entries in an item information database, and wherein the method further comprises:
generating, by the image analysis computer, an item information data entry that indicates that the one or more of the items from the one or more historical maps are not present in the current map; and
storing, by the image analysis computer, the item information data entry into the item information database, wherein the system further comprises:
the item information database.
